(19) United States
(12) Patent Application Publication
(10) Pub. No.: US 2007/0017759 A1
(43) Pub. Date: Jan. 25, 2007

(54) Shock Absorbing Structure

(76) Inventor: Shoei-Muh YUN, Taichung (TW)

Correspondence Address: BANGER SHIA, 204 CANYON CREEK, VICTORIA, TX, 77901, US

(21) Appl. No.: 11/420,878

(22) Filed: May 30, 2006

(30) Foreign Application Priority Data
Jul. 22, 2005 (TW) 094212493

(51) Int. Cl. F16F 9/34

(52) U.S. Cl. 188/299.1; 188/300; 188/319.2

(57) ABSTRACT

A shock absorbing structure comprises: a cylinder, a valve, a moveable tube, an adjusting tube and a valve rod. The valve rod, the adjusting tube and the moveable tube are coaxially arranged in a telescopic manner. The valve is fixed at an end of the moveable tube, and cooperates with an oil path to divide the cylinder into an oil pressure space and an air pressure space. Another end of the moveable tube cooperating with the adjusting tube and the valve rod protrudes out of the cylinder. The moveable tube is further provided with an oil return path. With the abovementioned arrangements, the user can turn on or off the buffering function of the shock absorbing structure freely. Furthermore, the operations of adjusting and turning on/off the buffering effect are all performed at the same end of the shock absorbing structure, therefore, the shock absorbing structure of the present invention is more suitable for modularization and is more simply structured.

### BACKGROUND OF THE INVENTION

1. Field of the Invention

The present invention relates to a shock absorbing structure, and more particularly to a shock absorbing structure used on vehicle, mechanical structure, the present invention is modularized and arranged in a variable space, the buffering function of the shock absorbing structure can be enabled or disabled freely according to user's needs. Furthermore, the operations of adjusting and turning on/off the buffering effect are all performed at the same end of the shock absorbing structure, therefore, the shock absorbing structure of the present invention is more suitable for modularization and is more simply structured.

2. Description of the Prior Art

A conventional shock absorber used on the bike usually utilizes inner spring cooperating with cylinder base and other components to produce a shock-absorbing effect (whether the operation space for the inner spring is filled with hydraulic oil is not the essential condition of the present invention, further discussions on this matter would be omitted). A conventional shock absorber, used on the bike, includes basement, axial shaft and shock-absorbing spring, which are to be explained below. The basement is mounted to the fork of the bike, while the axial shaft is mounted on the frame of the bike. The shock-absorbing spring is biased between the basement and the axial shaft. This kind of shock absorber has been used on different kinds of mechanisms and bikes, yet there are still some defects need to be improved as follows:

First, the conventional shock absorber has only a shock absorbing effect, but does not have a real-time regulating function. When riding up a slope, the up-and-down motion of the shock absorber will increase the drag force because the motion of the shock absorber counteracts the pressing force applied by the user. Therefore, most of the professional cyclists still have to choose different shock absorbing structures according to different riding surroundings.

Second, nowadays, most of the newest bicycle shock absorbing structures are provided with a very complicated hydraulic system, the connection between the respective parts makes it impossible to modularize the shock absorbing system, it is impossible for the user to replace or modify the parts by himself, and the installation and regulation of the shock absorbing structure have to be done by professionals.

The present invention has arisen to mitigate and/or obviate the afore-described disadvantages.

### SUMMARY OF THE INVENTION

The primary objective of the present invention is to provide a shock absorbing structure whose buffering function of the shock absorbing structure can be enabled or disabled freely during driving of the vehicle. The cylinder of the shock absorbing structure is divided into an oil pressure space and an air pressure space, the oil moves between the oil pressure space and the air pressure space, and the user can turn on and/or off the buffering function freely as desired. For example, when riding up a slope, the buffering function is disabled so as to prevent the increase of drag. When riding on a flat road, the buffering function is enabled, allowing the user to enjoy the comfortableness of the buffering effect. When riding down a slope, the buffering function of the front absorbing structure is disabled again, so as to prevent the increase of the front tilt angle of the bike and prevent the rider from falling over.

The secondary objective of the present invention is to provide a shock absorbing structure, wherein the buffering effect is adjustable at any time, the valve rod, the adjusting tube and the moveable tube are coaxially arranged in a telescopic manner. The moveable tube is further provided with an oil return path. With the abovementioned arrangements, the user can turn on or off the buffering function of the shock absorbing structure freely.

The present invention will be more clear from the following description when viewed together with the accompanying drawings, which show, for purpose of illustrations only, the preferred embodiment in accordance with the present invention.

### BRIEF DESCRIPTION OF THE DRAWINGS

FIG. 1 is an exploded view of showing a shock absorber in accordance with the present invention;

FIG. 2 is an assembly cross sectional view of showing the shock absorber in accordance with the present invention;

FIG. 3 is an illustrative view in accordance with the present invention of showing that the buffering function of the shock absorber is being disabled;

FIG. 4 is an illustrative view in accordance with the present invention of showing that the buffering function of the shock absorber is being enabled;

FIG. 5 is an enlarged view of showing the restoring process of the shock absorber in accordance with the present invention;

FIG. 6 is an operational view of showing the adjusting process of the shock absorber in accordance with the present invention; and

FIG. 7 is another operational view of showing the adjusting process of the shock absorber in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

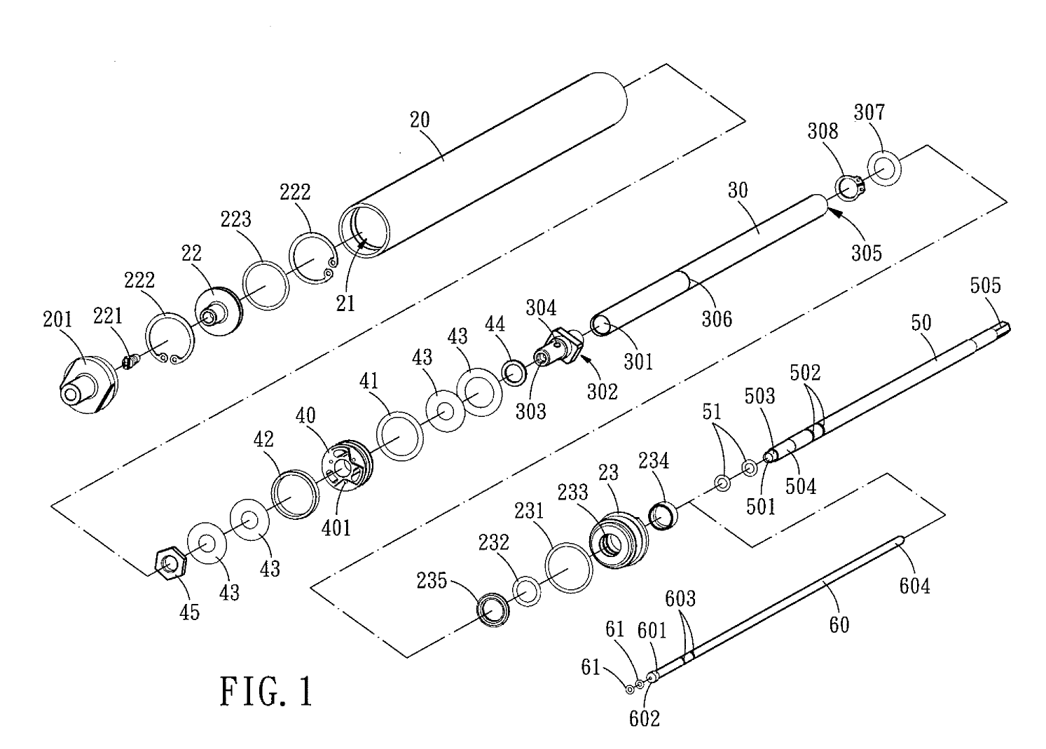

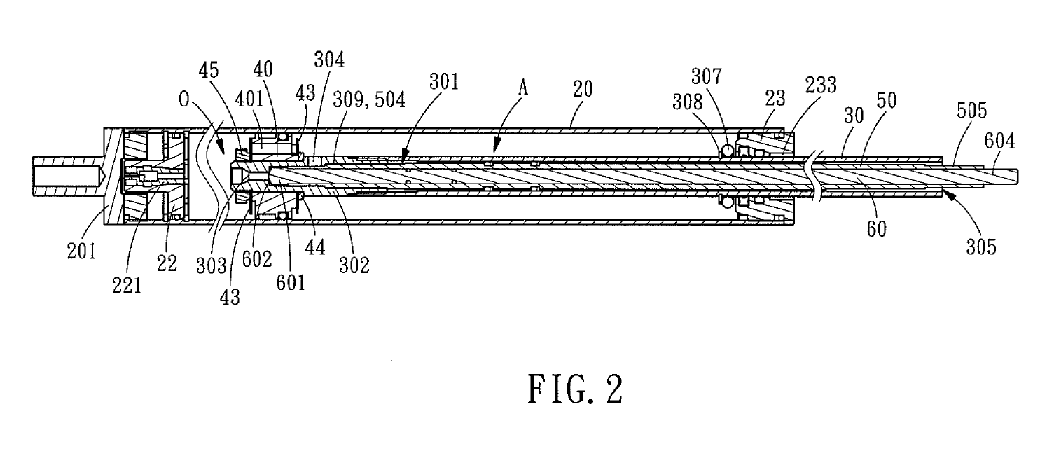

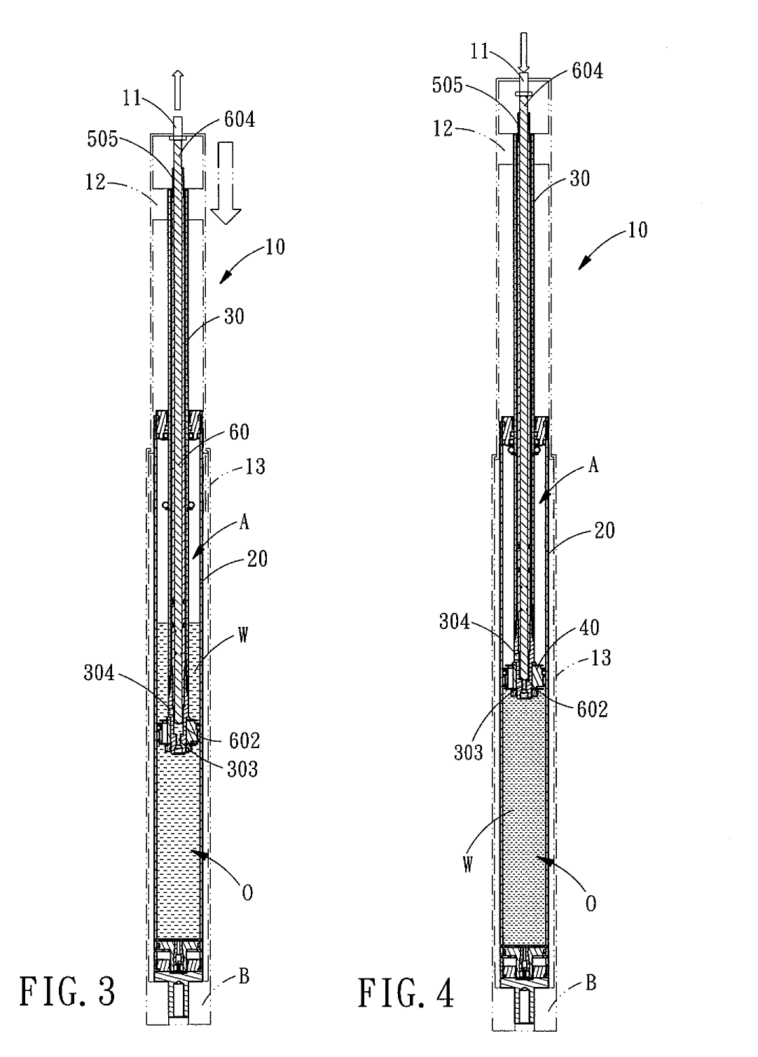

Referring to FIGS. 1-3, a shock absorber in accordance with the present invention is installed in a variable space 10 defined by a first housing 12 and a second housing 13. A pressing member 11 to be pressed by the user is disposed at the top end of the first housing 12 of the variable space 10. The variable space 10 can be located in the two-step telescopic tubes of the front fork, the shock absorbing tube, mechanical buffering space of the bicycle, and etc (the design of the variable space 10 is shown in FIG. 3).

The shock absorbing structure in accordance with the present invention essentially comprises a cylinder 20, a movable tube 30, a valve 40, an adjusting tube 50 and a valve rod 60.

The cylinder 20 is vertically positioned in the variable space 10, and the bottom of the cylinder 20 is fixed to the lower portion of the second casing 13 in the variable space 10 by an engaging cap 201. The cylinder 20 has an axial hole 21, a bottom sealing plug 22 is inserted in the axial hole 21 and is located opposite the engaging cap 201, and the bottom sealing plug 22 is sealed in the end of the axial hole 21 by two retainers 222 and a rubber ring 223. A non-return complementing tube 221 is disposed in the bottom sealing plug 22 for enabling the user to supply liquid to the axial hole 21. A top sealing plug 23 cooperating with an outer rubber ring231 is screwed in another end of the axial hole 21 of the cylinder 20. The top sealing plug 23 is axially formed with a sliding hole 233 in which an inner rubber ring 232, a sliding sleeve 234 and a sealing washer 235 are to be received.

The moveable tube 30 has an axial hole 301, an extending tube 302 is screwed to the axial hole 301 of the moveable tube 30 and is located opposite the bottom sealing plug 22 of the cylinder 20. A neck portion 303 is formed in the extending tube 302, and a return hole 304 is formed in the outer surface of the extending tube 302 and is located adjacent to the neck portion 303, thus forming an oil return path. An entrance 305 is formed at another end of the movable tube 301 opposite the extending tube 302. The movable tube 30 is inserted in the sliding hole 233 of the top sealing plug 23 of the cylinder 20, and the inner rubber ring 332, the sliding sleeve 234 and the sealing washer 235 of the cylinder 20 cooperate with each other to create an airtight seal between the movable tube 30 and the sliding hole 233 of the top sealing plug 23 of the cylinder 20. A limiting groove 306 is formed in the outer surface of the moveable tube 30 and servers to confine one end of the moveable tube 30 in the cylinder 20 by cooperating with an anti-collision washer 307 and a retainer 308. A plurality of inner threads 309 is formed on the inner surface of the axial hole 301 and is located beside the return hole 304. Another end of the movable tube 30 is fixed to the first housing 12 of the variable space 10.

The valve 40 is sealed in the axial hole 21 of the cylinder 20 by a rubber ring 41 and an outer sliding sleeve 42, defining the axial hole 21 into an oil pressure space O and an air pressure space A (the oil pressure space O is filled with oil W, and the air pressure space A is maintained at a predetermined air pressure). An oil path 401 is formed in the valve 40 and is located in the axial direction of the moveable tube 30. A plurality of reeds 43, an arm-of-force ring 44 and a fastener 45 work together as a check valve with a predetermined pressure to provide a non-return function to the oil path 401 of the valve 40. The valve 40 is fixed at the end of the moveable tube 30 by the fastener 45.

The adjusting tube 50 is formed with an axial hole 501 and is inserted in the axial hole 301 of the moveable tube 30. A plurality of positioning grooves 502 formed in the outer surface of the adjusting tube 50 cooperates with a plurality of rubber ring 51 to create an airtight seal between the adjusting tube 50 and the axial hole 301 of the moveable tube 30. A stop portion 503 is formed at one end of the adjusting tube 50, and a plurality of outer threads 504 is formed on the outer surface of the adjusting tube 50 for mating with the inner threads 303 of the moveable tube 30 and is located beside the stop portion 503. The stop portion 503 serves to adjust the flow rate of the return hole 304 of the moveable tube 30 through movement. Another end of the adjusting tube 50 is a polygonal adjusting end 505 to be protruded out of the entrance 305 of the moveable tube 30.

The valve rod 60 is formed at one end with an annular flange 601 and a conical surface 602, and is inserted in the axial hole 501 of the adjusting tube 50. A plurality of positioning grooves 603 formed in the outer surface of the valve rod 60 cooperates with a plurality of rubber rings 61 to create an airtight sealing effect. The conical surface 602 of the valve rod 60 is located opposite the neck portion 303 of the extending tube 302 of the moveable tube 30, and the annular flange 601 is confined in between the return hole 304 and the neck portion 303 of the moveable tube 30. Another end of the valve rod 60 is a control end 604 to be protruded out of the polygonal adjusting end 505 of the adjusting tube 50. The pressing member 11 of the variable space 10 serves to press against the control end 604.

For a better understanding of the embodiment, its operation and function, reference should be made to FIG. 3. When the shock absorbing function is enabled, the pressing member 11 in the variable space 10 is released and doesn't press against the valve rod 60 anymore, then the conical surface 602 of the valve rod 60 is released from the neck portion 303 of the extending tube 302 of the moveable tube 30, and as a result, the oil return path is open.

When the first and the second housings 12 and 13 are subjected to an inner pressure (the variable space 10 will be reduced in length), an end of the moveable tube 30 is forced into the cylinder 20. At this moment, the oil W in the oil pressure space O starts to move into the air pressure space A via the oil return path formed by the neck portion 303 and the return hole 304, and makes the moveable tube 30 move relative to the cylinder 20 (the first housing 12 and the second housing 13 move backward), and thus the shock absorbing structure of the present invention provides a very comfortable buffering effect at the initial stage.

After that, when the first and second housings 12 and 13 move back to a predetermined position, since the valve 40 moves together with the moveable rod 30 into the oil pressure space O, the oil W will flow into the air pressure space A. However, the air pressure space A is continuously squeezed by the surplus oil W, as a result, the air pressure of the air pressure space A will increase increasingly, and the oil W will flow more and more slowly into the air pressure space A, thus creating an effect that the buffering increases at the later stage of the shock absorbing process. The buffering of the present invention changes with the action of the vehicle, and this design produces a comparatively hard buffering effect in the end of the shock absorbing process.

Referring to FIG. 4, when the shock absorbing function is to be disabled, the user presses the pressing member 11 downward, the pressing member 11 in the variable space 10 is pressed against the valve rod 60, then the conical surface 602 of the valve rod 60 is pressed against the neck portion 303 of the extending tube 302 of the moveable tube 30, and as a result, the oil return path is closed.

When the first and the second housings 12 and 13 are subjected to an inner pressure (the variable space 10 will be reduced in length), an end of the moveable tube 30 is forced into the cylinder 20, and accordingly the valve 40 is forced to move toward the oil pressure space O from the air pressure space A. However, since the oil return path is closed by the conical surface 602 of the valve rod 60, the oil W in the oil pressure space O can't flow through the oil return path, plus the check valve in the oil path 401 of the valve 40 also prevents the flow of the oil W through the oil path 401 of the valve 40, as a result, the moveable tube 30 can't move relative to the cylinder 20, and thus the shock absorbing function is disabled.

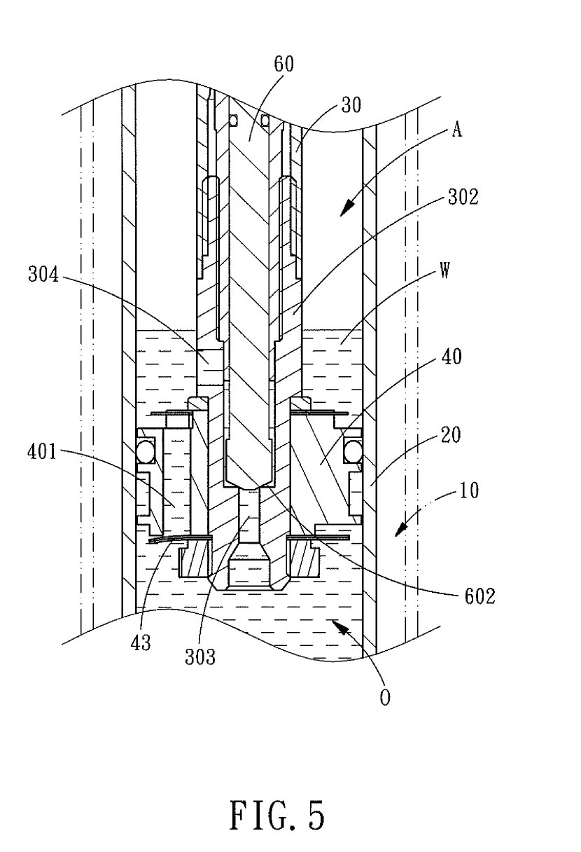

Referring then to FIG. 5, if the variable space 10 restores to its original length, the external pressure disappears, and the oil pressure of the oil W of the oil pressure space and the air pressure of the air pressure space A are brought into balance. Besides, the oil W that previously flowed into the air pressure space A returns to the oil pressure space O via the oil path 401 of the valve 40. By cooperating with the arm-of-force ring 44 and the fastener 45, the reeds 43 allow the oil W to flow back to gain balance, according to a predetermined pressure. Therefore, the shock absorbing structure will restore to its original position automatically after the external pressure disappears.

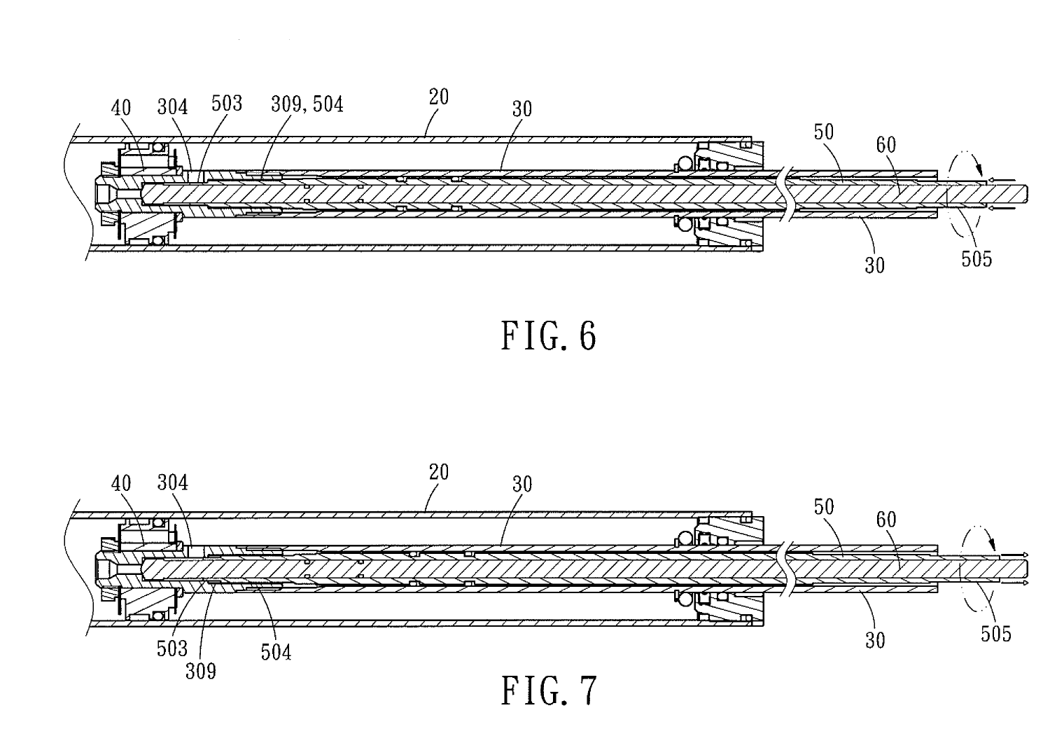

It is to be noted that, as shown in FIGS. 6 and 7, the adjusting tube 50 is inserted in the axial hole 301 of the moveable tube 30, and the adjusting tube 50 utilizes its stop portion 503 to adjust the flow rate of the return hole 304 of the moveable tube 30 through movement. By rotating the polygonal adjusting end 505 of the adjusting tube 50, an axial movement is caused between the stopping portion 503 of the adjusting tube 50 and the moveable tube 30. Therefore, the adjusting tube 50 allows the user to set the buffering effect as desired.

In addition, the shock absorbing structure in accordance with the present invention is completely modularized in design, and it can be installed in the variable space 10 according to the user' needs simply by fixing the cylinder 20 and the moveable tube 30 on two relatively moveable parts, respectively. As for the design of the pressing member 11, it has many conventional varieties, and further explanations on this matter will be omitted. The variable space 10 can be located in the two-step telescopic tubes of the front fork, the shock absorbing tube, mechanical buffering space of the bicycle, and etc.

Finally, the control end 604 of the valve rod 60 protrudes out of the polygonal adjusting end 505 of the adjusting tube 50, and the polygonal adjusting end 505 protrudes out of the entrance 305 of the moveable tube 30. It is clearly seen that the operations of adjusting and turning on/off the buffering effect are all performed at the same end of the shock absorbing structure, it is very convenient for regulating the variable space 10. Therefore, the shock absorbing structure of the present invention is more suitable for modularization and is more simply structured.

To summarize, the shock absorbing structure in accordance with the present invention comprises: a cylinder, a valve, a moveable tube, an adjusting tube and a valve rod. The valve rod, the adjusting tube and the moveable tube are coaxially arranged in a telescopic manner. The valve is fixed at an end of the moveable tube, and cooperates with an oil path to divide the cylinder into an oil pressure space and an air pressure space. Another end of the moveable tube cooperating with the adjusting tube and the valve rod protrudes out of the cylinder. The moveable tube is further provided with an oil return path. With the abovementioned arrangements, the user can turn on or off the buffering function of the shock absorbing structure freely. Furthermore, the operations of adjusting and turning on/off the buffering effect are all performed at the same end of the shock absorbing structure, therefore, the shock absorbing structure of the present invention is more suitable for modularization and is more simply structured.

While we have shown and described various embodiments in accordance with the present invention, it is clear to those skilled in the art that further embodiments may be made without departing from the scope of the present invention.

What is claimed is:

1. A shock absorbing structure comprising a cylinder, a moveable tube, a valve, an adjusting tube, and a valve rod, all of which being installed in a variable space, the cylinder and the moveable tube being disposed in the variable space and moveable relative to each other; wherein:
the cylinder is formed with an axial hole with both ends closed, and one end of the cylinder is axially defined with a sliding hole;
the moveable tube is formed with an axial hole, a neck portion is formed at an entrance of the axial hole, a return hole is formed adjacent to the neck portion, the return hole cooperates with the neck portion to form an oil return path, the moveable tube is inserted in the sliding hole of the cylinder, a plurality of inner threads is formed in the movable tube and located adjacent to the return hole;
the valve is fixed at an end of the moveable tube and serves to divide the cylinder into an oil pressure space and an air pressure space, an oil path is formed in the valve and is located in an axial direction of the moveable tube;
the adjusting tube is formed with an axial hole and is inserted in the axial hole of the moveable tube, a stop portion is formed at one end of the adjusting tube, a plurality of outer threads is formed on an outer surface of the adjusting tube for mating with the inner threads of the moveable tube and is located beside the stop portion, the stop portion serves to adjust flow rate of the return hole of the moveable tube through movement, another end of the adjusting tube is an adjusting end to be protruded out of the moveable tube; and
the valve rod is formed at one end thereof with a conical surface and is inserted in the axial hole of the adjusting tube, the conical surface of the valve rod is located opposite the neck portion of a extending tube of the moveable tube, another end of the valve rod is a control end to be protruded out of the adjusting end of the adjusting tube.

2. The shock absorbing structure as claimed in claim 1, wherein the cylinder is vertically positioned in the variable space, and a bottom of the cylinder is fixed to in the variable space by an engaging cap, a bottom sealing plug is sealed in an end of the axial hole of the cylinder, a non-return complementing tube is disposed in the bottom sealing plug for enabling the user to supply liquid to the axial hole of the cylinder, a top sealing plug is disposed at another end of the axial hole of the cylinder, and the top sealing plug is axially formed with the sliding hole.

3. The shock absorbing structure as claimed in claim 1, wherein the extending tube is screwed to the axial hole of the moveable tube and is located opposite the bottom sealing plug of the cylinder, a neck portion is formed in the extending tube as an entrance of the axial hole, a return hole is formed in the outer surface of the neck portion and located adjacent to the neck portion, thus forming an oil return path.

4. The shock absorbing structure as claimed in claim 2, wherein the extending tube is screwed to the axial hole of the moveable tube and is located opposite the bottom sealing plug of the cylinder, a neck portion is formed in the extending tube as an entrance of the axial hole, a return hole is formed in the outer surface of the neck portion and located adjacent to the neck portion, thus forming an oil return path.

5. The shock absorbing structure as claimed in claim 3, wherein a plurality of reeds, an arm-of-force ring and a fastener work together as a check valve with a predetermined pressure to provide a non-return function to the oil path of the valve.

6. The shock absorbing structure as claimed in claim 4, wherein a plurality of reeds, an arm-of-force ring and a fastener work together as a check valve with a predetermined pressure to provide a non-return function to the oil path of the valve.

7. The shock absorbing structure as claimed in claim 1 or 4, wherein the adjusting end of the adjusting tube is a polygonal adjusting end.

8. The shock absorbing structure as claimed in claim 5, wherein the adjusting end of the adjusting tube is a polygonal adjusting end.

9. The shock absorbing structure as claimed in claim 6, wherein the adjusting end of the adjusting tube is a polygonal adjusting end.

10. The shock absorbing structure as claimed in claim 1, wherein the variable space is defined by a plurality of housings, a pressing member to be pressed by the user is disposed at a top end of the variable space, after the control end of the valve rod protrudes out of the polygonal adjusting end of the adjusting tube, the pressing member of the variable space is used to control the control end.

11. The shock absorbing structure as claimed in claim 10, wherein the variable space is located in telescopic tubes of front fork, shock absorbing tube, mechanical buffering space of a bicycle.

12. The shock absorbing structure as claimed in claim 2, wherein the bottom sealing plug is sealed in one end of the axial hole of the cylinder by retainers and a rubber ring, a top sealing plug cooperating with an outer rubber ring is screwed in another end of the axial hole of the cylinder, an inner rubber ring, a sliding sleeve and a sealing washer are received in the sliding hole.

13. The shock absorbing structure as claimed in claim 1, wherein the cylinder is vertically positioned in the variable space, and a bottom of the cylinder is fixed to in the variable space by an engaging cap, a bottom sealing plug is sealed in an end of the axial hole of the cylinder, a non-return complementing tube is disposed in the bottom sealing plug for enabling the user to supply liquid to the axial hole of the cylinder, a top sealing plug is disposed at another end of the axial hole of the cylinder, and the top sealing plug is axially formed with the sliding hole;
the bottom sealing plug is sealed in one end of the axial hole of the cylinder by retainers and a rubber ring, a top sealing plug cooperating with an outer rubber ring is screwed in another end of the axial hole of the cylinder, an inner rubber ring, a sliding sleeve and a sealing washer are received in the sliding hole; and
a limiting groove is formed in an outer surface of the moveable tube and servers to confine one end of the moveable tube in the cylinder by cooperating with an anti-collision washer and a retainer.

14. The shock absorbing structure as claimed in claim 1, wherein the cylinder is vertically positioned in the variable space, and a bottom of the cylinder is fixed to in the variable space by an engaging cap, a bottom sealing plug is sealed in an end of the axial hole of the cylinder, a non-return complementing tube is disposed in the bottom sealing plug for enabling the user to supply liquid to the axial hole of the cylinder, a top sealing plug is disposed at another end of the axial hole of the cylinder, and the top sealing plug is axially formed with the sliding hole;
the bottom sealing plug is sealed in one end of the axial hole of the cylinder by retainers and a rubber ring, a top sealing plug cooperating with an outer rubber ring is screwed in another end of the axial hole of the cylinder, an inner rubber ring, a sliding sleeve and a sealing washer are received in the sliding hole;
a limiting groove is formed in an outer surface of the moveable tube and servers to confine one end of the moveable tube in the cylinder by cooperating with an anti-collision washer and a retainer; and
a plurality of positioning grooves formed in the outer surface of the adjusting tube cooperates with a plurality of rubber ring to create an airtight seal between the adjusting tube and the axial hole of the moveable tube.

15. The shock absorbing structure as claimed in claim 1, wherein the cylinder is vertically positioned in the variable space, and a bottom of the cylinder is fixed to in the variable space by an engaging cap, a bottom sealing plug is sealed in an end of the axial hole of the cylinder, a non-return complementing tube is disposed in the bottom sealing plug for enabling the user to supply liquid to the axial hole of the cylinder, a top sealing plug is disposed at another end of the axial hole of the cylinder, and the top sealing plug is axially formed with the sliding hole;
the bottom sealing plug is sealed in one end of the axial hole of the cylinder by retainers and a rubber ring, a top sealing plug cooperating with an outer rubber ring is screwed in another end of the axial hole of the cylinder, an inner rubber ring, a sliding sleeve and a sealing washer are received in the sliding hole;
a limiting groove is formed in an outer surface of the moveable tube and servers to confine one end of the moveable tube in the cylinder by cooperating with an anti-collision washer and a retainer;
a plurality of positioning grooves formed in the outer surface of the adjusting tube cooperates with a plurality of rubber ring to create an airtight seal between the adjusting tube and the axial hole of the moveable tube; and
a plurality of positioning grooves formed in an outer surface of the valve rod cooperates with a plurality of rubber rings to create an airtight sealing effect.

16. The shock absorbing structure as claimed in claim 1 or 6, wherein the control end of the valve rod protrudes out of the polygonal adjusting end of the adjusting tube, the polygonal adjusting end protrudes out of the entrance of the moveable tube, so that the operations of adjusting and turning on/off the buffering effect are all performed at the same end of the shock absorbing structure.

17. The shock absorbing structure as claimed in claim 10, wherein the control end of the valve rod protrudes out of the polygonal adjusting end of the adjusting tube, the polygonal adjusting end protrudes out of the entrance of the moveable tube, so that the operations of adjusting and turning on/off the buffering effect are all performed at the same end of the shock absorbing structure.
